(19) United States
(12) Patent Application Publication
(10) Pub. No.: US 2023/0244917 A1
(43) Pub. Date: Aug. 3, 2023

(54) CORRECTING MANIFOLD OVERFITTING OF PROBABILISTIC MODELS

(71) Applicant: THE TORONTO-DOMINION BANK, Toronto (CA)

(72) Inventors: Gabriel Loaiza Ganem, TORONTO (CA); Brendan Leigh Ross, Toronto (CA); Jesse Cole Cresswell, Toronto (CA); Anthony Lawrence Caterini, TORONTO (CA)

(21) Appl. No.: 18/083,345

(22) Filed: Dec. 16, 2022

Related U.S. Application Data
(60) Provisional application No. 63/305,481, filed on Feb. 1, 2022.

(51) Int. Cl. G06N 3/047; G06N 3/0455; G06N 3/088

(52) U.S. Cl. CPC G06N 3/047; G06N 3/0455; G06N 3/088

(57) ABSTRACT

To effectively learn a probability density from a data set in a high-dimensional space without manifold overfitting, a computer model first learns an autoencoder model that can transform data from a high-dimensional space to a low-dimensional space, and then learns a probability density model that may be effectively learned with maximum-likelihood. By separating these components, different types of models can be employed for each portion (e.g., manifold learning and density learning) and permits effective modeling of high-dimensional data sets that lie along a manifold representable with fewer dimensions, thus effectively learning both the density and the manifold and permitting effective data generation and density estimation.

### CROSS-REFERENCE TO RELATED APPLICATION

This application claims the benefit of provisional U.S. application No. 63/305,481, filed Feb. 1, 2022, the contents of which is incorporated herein by reference in its entirety.

### BACKGROUND

This disclosure relates generally to computer modeling of high-dimensional data spaces, and more particularly to probabilistic modeling of the high-dimensional data lying on a low-dimensional manifold embedded in high-dimensional ambient space.

As machine learning techniques and infrastructures become more sophisticated and increase performance on data sets, machine models are increasingly tasked with processing high-dimensional data sets and to generate new instances (also termed “data points”). Existing solutions struggle with effectively representing the complete range of a high-dimensional data set or in doing so in a low-dimensional space (e.g., representing a manifold of the relatively higher-dimensional data in a lower-dimensional space) while simultaneously permitting effective probabilistic modeling of the data. For example, while generative adversarial network (GAN) models have been used to learn to generate data in conjunction with feedback from a discriminative model, the generative model can neglect to learn how to generate certain types of content from the training data and do not model underlying probabilities. In other examples, some models like variational autoencoders (VAE) may be used to model high-dimensional data points with latent variables in a low-dimensional space, but because the observational space is in the high-dimensional space, the model may still implicitly model non-zero densities across the entire high-dimensional space and thus does not correctly learn that the probability should be zero for positions off-manifold.

Alternative solutions that do provide probabilistic information, such as normalizing flows, do not effectively learn densities for complex high-dimensional spaces in which the high-dimensional data lies on a manifold describable with a low-dimensional representation. In some examples, learning high-dimensional densities when the underlying data lies on a low-dimensional manifold can result in the trained model not properly detecting out-of-distribution data, that is, assigning higher densities to out-of-distribution data than to training data.

As such, while likelihood-based or explicit deep generative models use neural networks to construct flexible high-dimensional densities, this formulation is ineffective when the true data distribution lies on a manifold. Maximum-likelihood training (e.g., for density estimation) directly in the high-dimensional space yields degenerate optima, such that a model may learn the manifold, but not the distribution on it. This type of error termed herein: “manifold overfitting.” There is thus a need for an approach to effectively model data points of a high-dimensional space with effective probability density information while accounting for the data lying on a manifold in the high-dimensional space.

### SUMMARY

To address manifold overfitting and more effectively model high-dimensional data, such as data for images, video, and other complex data items, the model operates in two stages—first, an autoencoder that may encode and decode data between the high-dimensional space and the low-dimensional space, and second, a density model that learns a probability density of the data on the low-dimensional space. By reducing the data's dimensionality and then modeling the density, the model may effectively recover the position of data points within the high-dimensional space and apply a probability density to it based on the probability density learned in the low-dimensional space, thus avoiding manifold overfitting. With this approach, density estimation can be applied to model structures that reduce dimensionality implicitly, such as various types of generative networks, including generative adversarial networks (GANs).

To train these models, a training data set in a high-dimensional space is used to first train parameters of an autoencoder model that learns an encoder from the high-dimensional space to the low-dimensional space and a decoder from the low-dimensional space to the high-dimensional space. The autoencoder model may thus learn a mapping of the embedded manifold from the manifold in high-dimensional space to the low-dimensional space. The autoencoder may thus learn to transform points on the manifold (in the high-dimensional space) to the low-dimensional space, and to transform points in the low-dimensional space to the manifold in high-dimensional space, and in one embodiment may be bijective only for the manifold of the high-dimensional space and the low-dimensional space, and in some circumstances may apply to a region of the low-dimensional space (and may thus not be homeomorphic for other additional regions of the high-dimensional or low-dimensional space). The density model may then be trained with the training data as translated to the low-dimensional space, such that the density model is learned in the low-dimensional space and may be trained sequentially to the autoencoder model and using maximum-likelihood training approaches. This permits effective instance generation in the high dimensional space (e.g., to sample in the low-dimensional space and output in the high-dimensional space), along with density estimation and/or out-of-distribution evaluation of data in the high-dimensional space.

### BRIEF DESCRIPTION OF THE DRAWINGS

FIG. 1 illustrates a computer modeling system including components for probabilistic modeling of a high-dimensional space, according to one embodiment.

FIG. 2 shows an example of data points and a learned probability density.

FIG. 3 illustrates a high-dimensional space in which data points lie along a manifold, according to one embodiment.

FIG. 4 shows an example of manifold overfitting for data in a one-dimensional space, according to one embodiment.

FIG. 5 shows a model architecture for learning a probability density on a manifold, according to one embodiment.

FIG. 6 shows an example of the high-dimensional data points, learned manifold and low-dimensional space, and learned probability density, according to one embodiment.

FIG. 7 illustrates a further example of the encoder and decoder functions for translating between a high-dimensional space and low-dimensional space, according to one embodiment.

FIG. 8 provides an example comparison of the improved density estimation.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

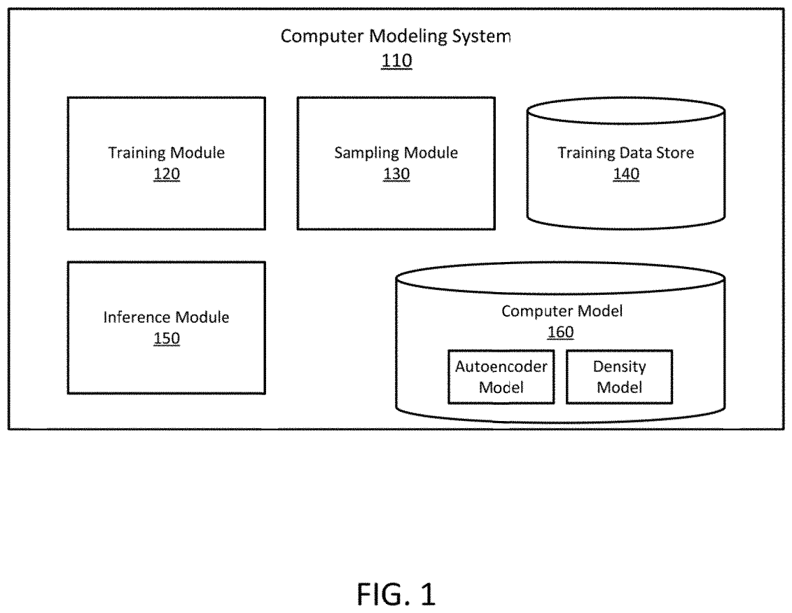

FIG. 1 illustrates a computer modeling system 110 including components for probabilistic modeling of a high-dimensional space, according to one embodiment. The computer modeling system 110 includes computing modules and data stores for generating and using a computer model 160. In particular, the computer model 160 is configured to represent high-dimensional data as a manifold in a low-dimensional space from which a probability density may be learned. That is, the computer model may include an autoencoder model that learns an encoder and decoder for learning a function for transforming a data point in high-dimensional space to and from (the encoder and decoder portions, respectively) a position in low-dimensional space, and a density model for representing the probability density of the data in the low-dimensional space. By learning the manifold and then the probability density in the low-dimensional space, the probability density may be learned and used to evaluate or produce high-dimensional data without manifold overfitting (e.g., without a training process that learns the manifold but fails to effectively learn the density or vice versa).

The computer model 160 is trained by the training module 120 to learn parameters for the autoencoder model and the probability density model based on the training data of training data store 140. Individual training data items are referred to as data points or data instances and may be represented in a “high-dimensional” space that may be represented as D dimensions (e.g., that may have real values [symbol] varying across the dimensions D, represented as [symbol] ^{D}). The computer model 160 learns a manifold [symbol] ⊂ [symbol] ^{D} in the high-dimensional space of the positions of the training data items by learning parameters for the autoencoder, including an encoder portion that encodes a high-dimensional data item to a position in low-dimensional space and decodes a position in the low-dimensional space to the high-dimensional space. The low-dimensional space has a dimensionality d (e.g., [symbol] ^{d}). The dimensionality d of the low-dimensional space is lower than the high-dimensional space (d<D) and in some instances may be significantly less than the high-dimensional space. As such, an encoder may represent a function ƒ for converting the high-dimensional space to the low-dimensional space: ƒ: [symbol] ^{D}→ [symbol] ^{d}. Similarly, the decoder may represent a function F for converting the low-dimensional space to the high-dimensional space: F: [symbol] ^{d}→ [symbol] ^{D}.

The computer model 160 also includes a density model that learns a probability density of the low-dimensional space based on the training data in the low-dimensional space (as converted to the low-dimensional space by the encoder). This enables the model to simultaneously address the appearance of the training data within a sub-region of the high-dimensional space (as the learned manifold) while also enabling effective probabilistic applications for the model using the probability density. As example applications, a point may be obtained (e.g., sampled) from the probability function to generate a data instance with the decoder, or the probability for the high-dimensional space may be determined by transforming a probability in the low-dimensional space (as given by the density model) to the high-dimensional space with the decoder. For example, a point in high-dimensional space may be encoded to determine the respective position in low-dimensional space, the probability determined in low-dimensional space with respect to the encoded position, and the probability transformed back to the high-dimensional space (e.g., to account for the change-in-variables) to represent the probability in the high-dimensional space.

By separating these functions and learning them separately, the computer model 160 may effectively learn a probability density despite that the training data may be located on a previously undefined or unknown manifold [symbol] of the high-dimensional space. As further discussed below, the models may also be trained with respective training objectives. The autoencoder may be trained with respect to a reconstruction error (e.g., based on minimizing a difference between the original position of a training data point in the high-dimensional space and the position after the point is encoded and subsequently decoded). The density model may be trained with a maximum-likelihood training objective over the distribution of training points in low-dimensional space, which due to manifold overfitting, often cannot be performed effectively in the high-dimensional space.

After training, the sampling module 130 may sample outputs from the probabilistic computer model 160 by sampling a value from the density model in a low-dimensional space and transforming the sampled value to an output in the high-dimensional space, enabling the model to generatively create outputs similar in structure to the data points of a training data store 140 while accurately representing the probability density of the training data set (i.e., overcoming the manifold overfitting). Similarly, an inference module 150 may evaluate probabilities using the density model, e.g., by receiving a new data point(s) in the high-dimensional space and convert it to a point(s) in the low-dimensional for evaluation with respect to learned probability density. This may be used to determine, for example, whether the new data point or set of points may be considered “in-distribution” or “out-of-distribution” with respect to the trained probability density. Further details of each of these aspects is discussed further below.

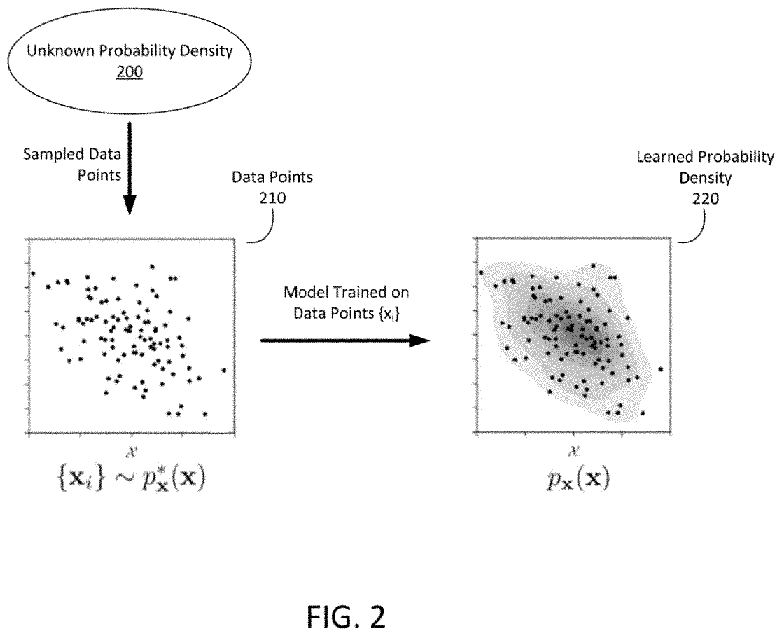

FIG. 2 shows an example of data points and a learned probability density 220. In general, data points for which the model is trained are considered to be sampled (or generated) from an unknown probability density 200. Each of the data points 210 has a set of values in the dimensions of a high-dimensional space, and thus can be considered to represent a position in the high-dimensional space. Formally, the data points 210 may also be represented as a set of points, {xᵢ} drawn from the unknown probability density pₓ*(x). The unknown probability density may also be termed a “sampled probability density” (i.e., the probability density from which the training data is drawn) or a ground truth probability density (in circumstances in which the underlying probability density can be known, such as in certain experimental conditions). The model is trained to learn a probability density pₓ(x) as represented by trained/learned parameters of the computer model based on the data points {xᵢ}. Typically, the learned probability density 220 is intended to minimally diverge from the unknown probability density 200 from which the data points were sampled. That is, whatever data distribution and frequency from which the data points were sampled is intended to be recreated in the learned probability density 220.

In many cases, however, high-dimensional data lies on a manifold [symbol] of the high-dimensional space, such that directly learning a probability density on the high-dimensional data may prove both ineffective and require many parameters to describe in particularly high-dimensional data sets. In general, the high-dimensional space has a number of dimensions referred to as D, and the low-dimensional space has a number of dimensions referred to as d. While the concepts discussed herein may apply to situations in which the high-dimensional space is relatively higher than the low-dimensional space (e.g., d<D) and may thus apply to dimensions of D=3 and d=2, in many cases, the high-dimensional space may have tens or hundreds of thousands, or millions of dimensions, and the low-dimensional space may have fewer dimensions by an order of magnitude or more.

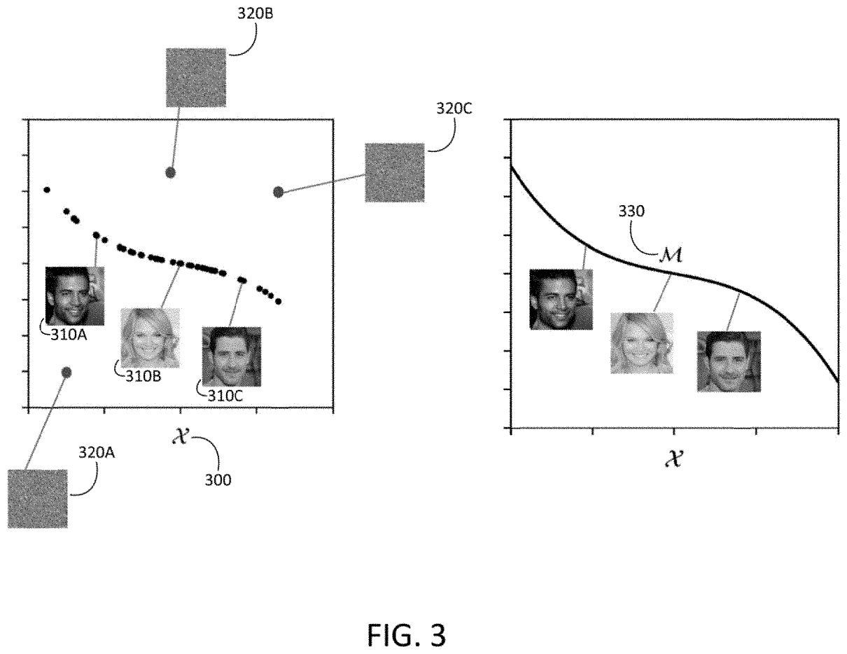

FIG. 3 illustrates a high-dimensional space in which data points lie along a manifold. In this example, the high-dimensional space 300 represents image data in two dimensions. Each point of high-dimensional image data represents an image having dimensions that may have a value for each channel (e.g., 3 channels for RGB color) for each pixel across a length and width of the image. Hence, the total dimensional space for an image data point in the high-dimensional space 300 for this example is the image length times the width times the number of channels times the bit length representing the color value: L×W×C×B. Stated another way, each color channel for each pixel across the image can have any value according to the bit length. In practice, however, only some portions of the complete dimensional space may be of interest and are represented in the training set. While the range of the complete high-dimensional image space can be used for any possible image, individual data sets typically describe a range across a subset of the high-dimensional space 300. In this example, a data set of human faces include data points 310A-C. However, many points in the image data space do not represent human faces and may have no visually meaningful information at all, such as data points 320A-C, depicting points in the high-dimensional space that have no relation to the type of data of the human face data set. As such, while the high-dimensional space 300 may permit a large number of possible positions of the data points in the high-dimensional space, in practice, data sets (e.g., human faces) represent some portion of the high-dimensional space may be characterized in fewer parameters (i.e., in lower dimensions) than those available in the high-dimensional space. The region of the high-dimensional space on which data points may exist may be described as a manifold 330 of the high-dimensional space 300. As discussed below, the shape of the manifold 330 in the high-dimensional space may be learned through the encoder and decoder of the autoencoder model that learns to characterize the positions of data points in the high-dimensional space 300. The manifold 330 is thus learned to generally describe the “shape” of the data points within the high-dimensional space 300 and may be considered to describe constraints on the areas in which data points exist and the possible interactions and relationships between them. For example, a data set of human faces may generally exist in a region of possible images in which there is a nose, eyes, mouth, and the image is mostly symmetrical.

Model structures that learn a probability density for data that lies on a manifold in high-dimensional space (e.g., as shown in FIG. 3), often errs and instead learns the manifold without effectively learning the probability density (e.g., accurately learning the relative frequency of particular points in the high-dimensional space).

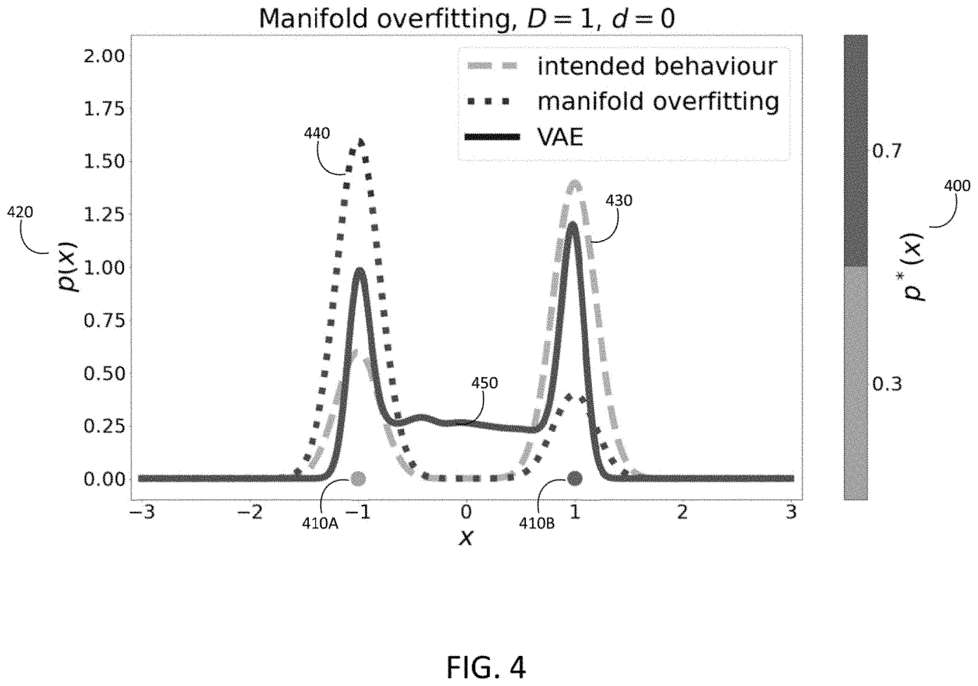

FIG. 4 shows an example of manifold overfitting for data in a one-dimensional space, according to one embodiment. In this example, the high-dimensional space has a dimensionality D=1 (values along a line), the ground truth probability density p*(x) 400 has a dimensionality d=0 as a pair of point values 410A, 410B having values −1 and 1, that are sampled at a probability frequency of 0.7 (70%) for the point value of 1, and probability frequency of 0.3 (30%) for the point value of −1. The probability of this ground truth probability may be formally given by:

[symbol]

*=0.3δ₋₁+0.7δ₁ Equation 1

In which δ₋₁ and δ₁ are the point masses for −1 and 1, respectively.

FIG. 4 illustrates example probability densities p(x) 420 that may be learned based on data sampled from the ground truth probability density p*(x) 400. Consider, for example, attempting to model the ground truth density of Equation 1 (having a dimensionality of 0) in the higher dimensional space in which D=1 as a mixture of two gaussian distributions. In this example model, the gaussians [symbol] each have respective means m₁ and m₂, a shared variance σ² and the respective gaussians may be sampled with a mixture weight λ, from zero to one (λ∈[0, 1]) describing a frequency of sampling from each gaussian distribution. Formally this may be given by:

p(x)=λ· [symbol] (x;m₁,σ²)+(1−λ)· [symbol] (x;m₂,σ²) Equation 2

The density model of Equation 2 is capable of correctly and exactly modeling the ground truth probability density 400 by learning a value of −1 for first mean m₁, a value of 1 for the second gaussian at the value 1, the variance approaching 0, and a mixture weight λ, of 0.3 (to sample 30% from the first gaussian and 70% from the second gaussian). In training parameters of the model to learn the ground truth probability density 400, the intended behavior 430 may thus be to learn the respective means, variance, and mixture by iteratively revising the parameters with a likelihood maximization training cost (which may also be termed “maximum-likelihood”), in which the parameters are revised by at each training iteration steps with the intent of maximizing the likelihood of correctly capturing the ground truth probability density p*(x) 400 (as observed from the sampled points) by modifying the learnable model parameters. It may be possible to learn the correct distribution when is model is initialized with the correct mixture weight:

pₜ(x)=0.3· [symbol] (x;−1,1/t)+(0.7)· [symbol] (x;1,1/t) Equation 3

When training a model based on initial starting parameters of Equation 3, the model parameters could possibly learn the correct ground truth distribution (i.e., by setting the mixture weights a priori); however, when actually training the model with maximum-likelihood, the objective does not actually encourage this desired behavior above other distributions that can also be learned (i.e., training of Equation 2 does not necessarily encourage learning a value of 0.3 for λ).

That is, this maximum-likelihood approach, which can be effective for training complex models when there is not a dimensionality mismatch (e.g., the data does not lie on a manifold effectively represented in a lower dimensionality), may in this instance recover many probabilities that are not the correct ground-truth probability density 400. Instead, maximum-likelihood training may yield parameters exhibiting a manifold overfitting distribution 440 as shown in FIG. 4, showing that while the manifold may be learned (e.g., means m₁ and m₂ at the values of −1 and 1), the respective distribution of points may err and may be incorrectly learned. For example, the manifold overfitting distribution 440 may represent the example above but that learns an incorrect mixture weight of 0.8 in favor of the gaussian at −1 as equation 4:

pₜ(x)=(0.8)· [symbol] (x;−1,1/t)+(0.2)· [symbol] (x;1,1/t) Equation 4

As such, when trained with maximum-likelihood, however, parameters for a distribution [symbol] ₀ that is on the manifold but with an incorrect distribution: [symbol] ₀=0.8δ₋₁+0.2δ₁, and may further be trained to arbitrarily high likelihoods, i.e., p′ₜ(x)→∞ as t→∞ for x∈ [symbol] .

This may occur, for example, because the distribution exhibiting manifold overfitting achieves high likelihoods with respect to p*(x) due to the dimensionality mismatch. Because sampled points never include off-manifold points and the manifold is significantly smaller (i.e., representable in fewer dimensions) than the total space of the high-dimensional space, training iterations may obtain local optima that fail to learn the correct distribution, as the probability of any point on the manifold can diverge towards infinity relative to the probability of off-manifold points. As such, as further discussed below, even with infinite data samples from the sampled distribution p*(x), subsequent training iterations with maximum-likelihood may be dominated by terms for learning the manifold rather than learning the distribution on the manifold.

A Gaussian variational autoencoder was trained on this data sample to provide another example of manifold overfitting, which is shown as a learned VAE distribution 450. Although it learned the manifold (spiking probabilities at −1 and 1), the VAE distribution 450 has probabilities that begin to diverge towards infinity (i.e., individual regions spike above 1) and incorrectly learns the relative frequencies of −1 and 1. Because the sampled data from p*(x) lies on the manifold as a small portion of the total space of the high-dimensional space, the maximum-likelihood training (e.g., for the learned distributions of the example manifold overfitting distribution 440 or the VAE distribution 450) approach with a dimensional mismatch (the data in fact lies on a manifold) may thus recover the manifold only and can iteratively “learn” parameters for incorrect relative distributions within the manifold. Stated another way, as more and more points are sampled from p*(x), the number of sampled points (in dimension D) that are on the manifold approach infinity, while points off-manifold remain zero. As such, iterations of maximum-likelihood training may fail to converge on the correct probability because the maximum-likelihood evaluation is dominated by correctly identifying the manifold itself. This may yield parameter training based on likelihood maximization that may only learn the manifold correctly.

As another way of understanding manifold overfitting, when the probability model attempts to learn a continuous probability density in a space having dimensionality D (e.g., points are represented as having respective values varying along each dimension in D), it attempts to learn a probability density as a continuous function that can be instantaneously evaluated at points in D as non-zero values. In addition, as a probability, integrating the density across the entirety of D is intended to yield an accumulated probability of 1. That is, accumulating the probability density of a region in D as an integral is the accumulation of each respective “volume” with respect to D multiplied by the probability density for each point in the volume.

However, when the data lies on a manifold of dimensionality d, the learned volume with respect to D approaches zero. Described intuitively, this may be like measuring a three-dimensional volume of a circle or measuring the two-dimensional area of a line segment—by lacking a value in the additional dimension, the volumetric measurement of the lower-dimensional data with respect to higher dimension is zero. For example, as shown in the example of FIG. 4, maximum-likelihood training may attempt to accumulate a probability by integrating the probability density across a length (the “volume” measurement for D=1). When the data actually exists on fewer dimensions (here, two points), the correct “volume” in D (i.e., here, a “length” along one dimension) for the probability density integration approaches zero. As the “volume” approaches zero, the model training may thus modify parameters for the underlying probability density towards infinity for any points on the manifold based on the dimensionality mismatch alone, without any guarantee of learning the correct relative distribution on the manifold.

As suggested by the above, this effect is not resolved by additional data samples from p*(x) and is not the result of traditional notions of the model parameters “overfitting” individual data points. Rather, it arises from the dimensional mismatch that is not cured by additional data because increasing the number of samples causes the number of samples for every on-manifold point to approach infinity, while the off-manifold points remain zero and does not address the measured “volume” in D to cause the probability density to approach infinity. This problem with manifold overfitting may thus occur even for model structures that represent data with low-dimensional latent variables, such as a variational autoencoder (VAE) or Adversarial Variational Bayes (AVB) models, because these models may still evaluate maximum-likelihood directly in the high-dimensional space and imply that each point in the high-dimensional space has a positive density.

### General Autoencoder and Probability Density Modeling

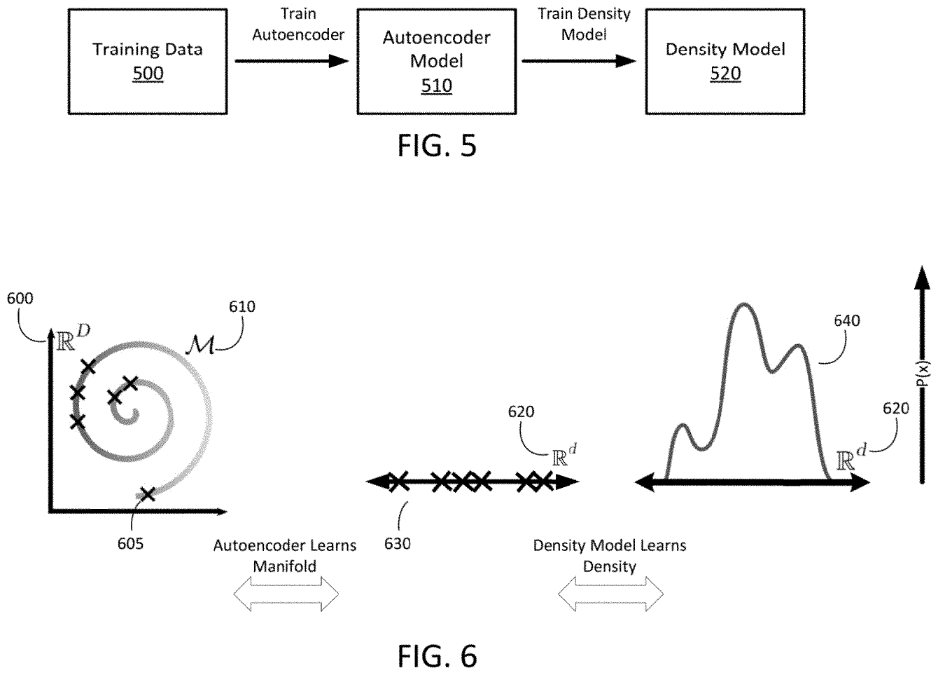

FIG. 5 shows a model architecture for learning a probability density on a manifold, according to one embodiment. To resolve the manifold overfitting problem discussed above, the overall model may first learn an autoencoder model 510 that can learn the manifold of high-dimensional space in a low-dimensional space and a density model 520 that learns the density of the points in the low-dimensional space. By learning the manifold and the probability density separately, maximum-likelihood training can be effectively applied to correctly learn parameters of the density model 520. That is, by translating points through the autoencoder to the low-dimensional space, the dimensionality mismatch disappears when training the density model 520 with respect to the low-dimensional space.

FIG. 6 shows an example of the high-dimensional data points, learned manifold and low-dimensional space, and learned probability density, according to one embodiment. The high-dimensional space 600 may include the various sampled data points 605. The autoencoder model learns the manifold 610 and respective translation to the low-dimensional space [symbol] ^{d} 620 to determine respective low-dimensional positions 630 in the low-dimensional space 620. The density model may then effectively learn the density 640 in low dimensional space 620 effectively without the dimensionality mismatch.

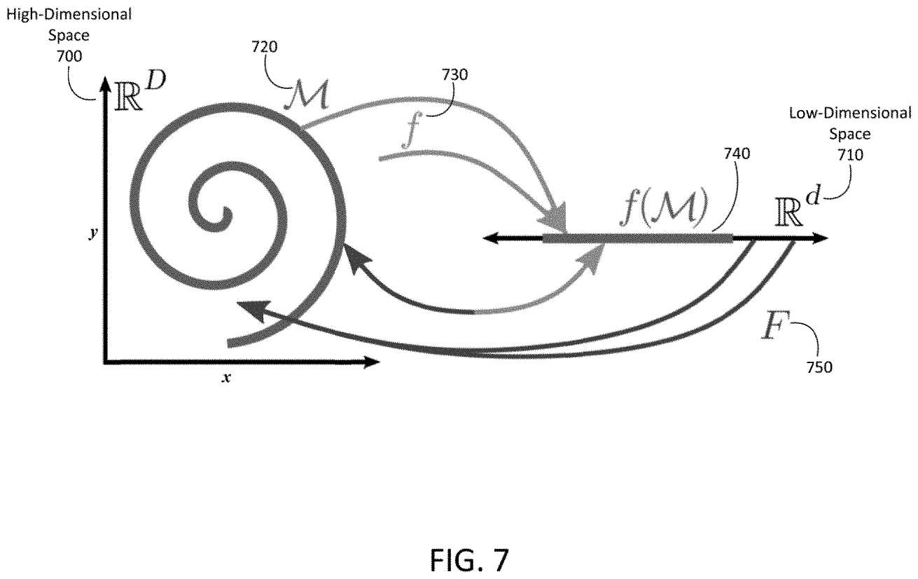

FIG. 7 illustrates a further example of the encoder and decoder functions for translating between a high-dimensional space 700 and low-dimensional space 710, according to one embodiment. The autoencoder includes an encoder ƒ 730 that receives a data point in the high-dimensional space 700 and determines a corresponding position in the low-dimensional space. Similarly, the decoder F 750 receives a position in the low-dimensional space and translates it to a data point in the high-dimensional space 700. As such, the encoder 730 and decoder 750 may be selected from any suitable model for which points may be translated from the learned manifold in the high-dimensional space to the low-dimensional space and back without (or minimal) reconstruction loss, e.g., to optimize F and f such that F(ƒ(x))=x for every x∈ [symbol] . Stated another way, encoding a point on the manifold and decoding the result yields the same point.

As such, although termed an “autoencoder,” autoencoders as used herein may include more than typical/traditional “autoencoder” models. Other model types that provide for (or may be modified to provide) effective encoding of the manifold and recovery thereof may be used. As such, the encoder and decoder may be bijective along the manifold. As shown in FIG. 7, the encoder 730 may convert the manifold 720 to a region 740 of the low-dimensional space and recovery of the manifold 720 from the region 740 of the low-dimensional space. As such, points that are off-manifold in the high-dimensional space may not be decoded to recover the same off-manifold point, and points that are out of the region 740 in the low-dimensional space 710 may not be decoded to points on the manifold 720. As such, the encoder and decoder may not be injective across the entire high- or low-dimensional spaces, and may only be bijective for the manifold (particularly the sampled data points used to train the model).

Accordingly, additional types of models beyond a traditional autoencoder (AE) for use as an encoder and/or decoder may include other types of models that learn lower-dimensional representations that may be returned to high-dimensional representations. These may include continuously differentiable injective functions that are bijective over [symbol] on its image (i.e., the corresponding region in the low-dimensional space). In addition, the models may explicitly learn such functions, or may implicitly learn them as a result of learning low-dimensional representations, for example in generative models that may learn a “decoder” in the form of a function that generates a high-dimensional position based on a low-dimensional representation.

Types of models that may be used as the autoencoder and to learn an encoder model parameters and/or decoder model parameters include:
Autoencoders (e.g., neural networks that learn parameters for encoding input to a low-dimensional space and decoding to recover the input)
Variational Autoencoder (VAE) (in which the encoder and decoder are the encoder and decoder mean of the VAE)
Wasserstein Autoencoder (WAE) (in which the encoder and decoder are the encoder and decoder mean of the WAE)
Adversarial Variational Bayes (AVB)
Bi-directional Generative Adversarial Network (bidirectional GAN)

Additional types of generative models (e.g., generative adversarial models) may be used to learn the autoencoder by learning the decoder F based on parameters of the GAN (e.g., that can use a point in low-dimensional space for which the model can generate a high-dimensional output), and learning an encoder ƒ based on a reconstruction error of the training data points. In some embodiments, rather than learning an explicit encoding function ƒ, the respective low-dimensional point for a high-dimensional data point (e.g., training data points) may be determined as the positions in low-dimensional space for which the decoder recovers the high-dimensional data point (e.g., for xₙ in high-dimensional space, determining zₙ in low-dimensional space such that F(zₙ)=xₙ). As such, the autoencoder may generally be described as learning the decoder function F and an encoder function ƒ either explicitly, alternatively, implicitly as a point zᵢ in the low-dimensional space as respective points {zₙ}ₙ₌₁^{N} for input points {xₙ}ₙ₌₁^{N} (e.g., the training data or, in certain applications, for the test data).

Thus, the encoder and decoder may be trained (as an explicit training objective or as a result of the training process) in a way that minimizes the expected reconstruction error, one of example of which is shown in Equation 3:

[symbol]

_{X˜} [symbol] _{*}[∥F(ƒ(X))−X∥] Equation 5

As shown in Equation 5, the reconstruction error may be measured in one embodiment as the distance between each training data point Xᵢ in the training data set X (sampled from unknown density P*) and the reconstructed position of the training data point Xᵢ after applying the encoder ƒ( ) and subsequently the decoder F( ). I.e., the reconstruction error may aim to minimize the difference between Xᵢ and F(ƒ(Xᵢ)) across the data set X.

After determining the encoder and decoder as just discussed, the density model may be learned as shown in FIGS. 5 and 6. The density model (e.g., density model 520) may include any type of density model that may effectively learn a probability density when there is not a dimensionality mismatch, as the density model may also learn the probability density on the low-dimensional space. As such, the distribution may be learned with maximum-likelihood training, such as a VAE, AVB, normalizing flows (NF), energy-based model (EBM), autoregressive model (ARM), or other density estimation approaches. The probability density may be learned based on the training data points, as converted to the low-dimensional space according to the encoder.

The respective model architectures may be independently selected (e.g., the model architecture for the autoencoder model 510 and for the density model 520) and thus enable wide variation of types of model architectures that may overcome the manifold overfitting issue. As such, this framework may provide for many types of density models that may not require injective transformations over the entire low-dimensional space.

As such, the respective model architectures for the autoencoder model 510 and density model 520 (e.g., as components of the computer model 160) may be trained by the training module 120 based on the training data in the training data store 140. That is, the autoencoder model may be trained to learn the encoder and decoder based on a reconstruction error of the training data points (which lie on the manifold in the high-dimensional space). Then, the training data may be converted to respective positions in the low-dimensional space by applying the learned encoder and used to learn the probability density as the parameters of a learned density model using, e.g., a maximum-likelihood training loss. This permits the model as a whole to correctly learn both a low-dimensional representation and to learn a probability thereon, enabling, e.g., a generative model, that successfully models probability densities for data on a manifold in the high-dimensional space.

After training, to generate data points in high-dimensional space, the sampling module 130 may sample a point in the low-dimensional space from the density model and then apply the decoder to convert the low-dimensional point to a data instance in the high-dimensional space as an output of the computer model 160.

In addition, the inference module 150 may use the computer model 160 to perform various probabilistic/density measures on high-dimensional data points. To evaluate probabilities in the high-dimensional space, probabilities for a point in high-dimensional space may be determined by a change-of-variable formula applied to the respective density in the low-dimensional space:

$$p x ( x ) = p z ( f ( x ) ) {\vert det {J}_{F}^{T} ( f ( x ) ) {J}_{F} ( f ( x ) ) \vert}^{- \frac{1}{2}} \qquad Equation 6$$

The change-of-variable formula in Equation 6 provides that the probability density at point x in high-dimensional space (px(x)) (for a point x on the low-dimensional manifold), may be evaluated by determining the encoded position of x in low-dimensional space (i.e., ƒ(x)), determining the probability density pz in the low-dimensional space (as given by the density model) evaluated at the encoded position (together forming (pz(ƒ(x)) and returned to the high-dimensional space based on the change-of-variable Jacobian determinant (and its transverse) of the decoder F evaluated at the encoded position of x in low-dimensional space. I.e., the decoder F applied to the determinant of the Jacobian J_{F} and its transpose J_{F}^{T} for the decoder function F at the low-dimensional point ƒ(x) (together the

$${\vert det {J}_{F}^{T} ( f ( x ) ) {J}_{F} ( f ( x ) ) \vert}^{- \frac{1}{2}}$$

term). In some embodiments in which the decoder architecture may not directly provide the Jacobian at ƒ(x), the Jacobian and its transverse may be determined by automatic differentiation.

The probability density evaluation in the high-dimensional space may permit, for example, evaluation of various density/probabilistic functions by the inference module 150 to successfully evaluate data points in high-dimensional space based on the low-dimensional density. Where Equation 6 may be used to obtain a probability for a point in high-dimensional space, the inference module in some embodiments may perform probability measurements based on encoding the high-dimensional points to the low-dimensional space and evaluating the probability density using the probability model.

For example, analysis may be performed to evaluate a test data set's correspondence to the original training dataset and whether the test data set was likely to have been obtained from the same underlying (typically unknown) probability density P*. This may also be termed out-of-distribution analysis—determining the extent to which the test data set may be in- or out-of distribution with respect to the training data set. The out-of-distribution analysis may be performed in a variety of ways, some examples of which are provided below.

As one example of out-of-distribution analysis, the test data set may be analyzed with respect to the autoencoder to determine whether the test data set lies on a different manifold than the original training data set. To do so, the test data set may be encoded by ƒ and decoded by F to determine whether the encoder and decoder yield different reconstruction errors for the test data set than for the training data set (e.g., as an average or as an accumulated total, a maximum reconstruction error, or another metric). Because the encoder and decoder are generally trained to encode data on the manifold and to recover points on the manifold (e.g., as discussed with respect to FIG. 7), a data set that is on a different manifold of the high-dimensional space may not by correctly recovered by the trained autoencoder. As such, when the reconstruction error of the different data set differs from the reconstruction error of the training data set, it may indicate that the test data set was not obtained from the same probability density P* that generated the training data set. Formally, this may be determined by determining a first reconstruction error for a first data set (e.g., the training data set), determining a second reconstruction error for the second data set (e.g., an evaluated data set), and determining a similarity score based on the first and second reconstruction errors. The similarity score may be based on a comparison of statistical measures of the respective reconstruction errors, such as the mean, median, maximum, or another measure of the reconstruction error for individual data points in the respective data sets.

As another example, the data points in the test data set may be encoded to the low-dimensional space for evaluation of the low-dimensional points (of the test data set) with respect to the learned probability density of the training data set in the low-dimensional space. For example, the probability of test points in the test data set may be determined based on the change-of-variable formula of Equation 6 to determine the probability of the respective points in the high-dimensional space compared with the points in the training data set. In another example, the test data points in the low-dimensional space may be compared with the density distribution to determine, for example, whether the assigned likelihoods are low relative to the training data, and thus whether the test data points are likely from a different data distribution. In another example, another density distribution may be learned for the test data set based on the encoded test data points (i.e., in low-dimensional space), and the test density distribution may be evaluated against the density distribution of the training data to determine the divergence of the test density distribution.

As another example, the probability of data points in a first data set (e.g., the training data set) and the probability of data points in a second data set (e.g., a validation data set, which may be known to differ in composition from the test data set) may have the probability of each data point evaluated according to the trained density model, such as via Equation 6. A classifier (e.g., a decision stump) may be trained on the resulting probabilities to learn a threshold probability value for predicting membership in the first data set, trained based on the probability values of the first data set as in-member examples and the probability values of the second data set as out-of-class examples. The individual data samples for each data set may then be evaluated based on the threshold to determine the frequency that the first or second data sets are correctly predicted as being members of the first data set. This approach may be used, for example, to evaluate the frequency that instances of the second data set may be predicted to belong to the density learned based on the first data set. When the first and second data sets are known to have significantly different composition, the frequency may be used to evaluate how well the model learned the actual density of the first data set.

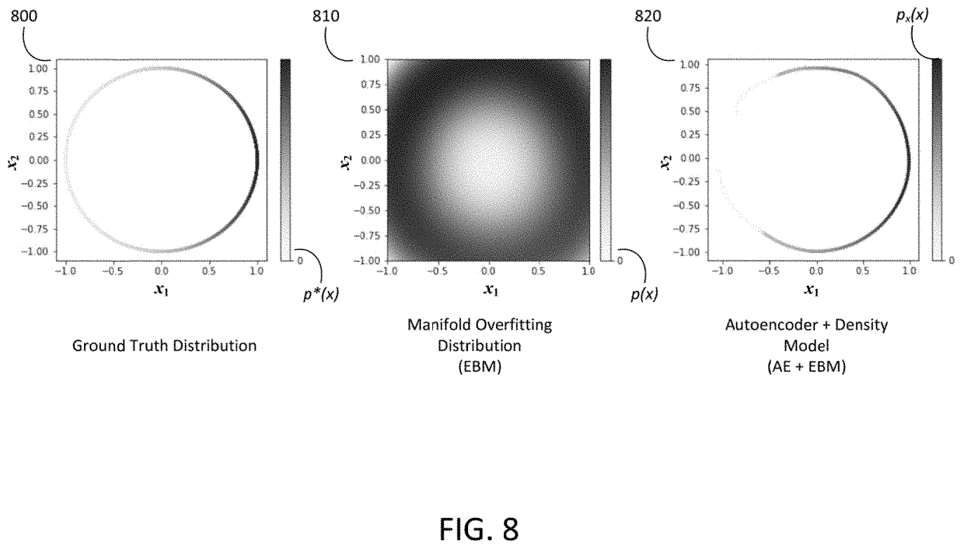

FIG. 8 provides an example comparison of the improved density estimation using embodiments discussed herein. A ground truth distribution 800 shows the known probability distribution for a von Mises distribution on the unit circle, having a high density on the right side of the unit circle towards x=1, y=0, with decreasing density towards the left side of the unit circle at x=−1, y=0. An energy-based model (EBM) was trained to learn data points sampled from the ground truth distribution 800 yielding a manifold overfitting distribution 810. As expected from the manifold overfitting theory, while the EBM model successfully learned the manifold as shown by its heightened probability density around the unit circle, it incorrectly assigned higher density towards the top of the circle and failed to successfully learn the correct distribution on the manifold. Another distribution 820 is learned by a model according to architecture discussed herein. When an autoencoder learns the manifold and then a density model learns the density (here, the autoencoder is a traditional autoencoder and the density model is an energy-based model), the resulting distribution 820 correctly learns both the manifold and the distribution as shown. The AE+EBM model not only learns the manifold more accurately, it also assigns higher likelihoods to the correct part of it.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for density estimation of a data set in a high-dimensional space comprising:
a processor that executes instructions; and
a non-transitory computer-readable medium having instructions executable by the processor for:
training an autoencoder model based on a set of training data in a high-dimensional space, the autoencoder model having an encoder portion for encoding data in a high-dimensional space to a low-dimensional space and a decoder portion for decoding data from the low-dimensional space to a learned manifold of the high-dimensional space;
applying the encoder portion to the training data to determine respective positions of the training data in the low-dimensional space;
training a density model to learn a probability density of the low-dimensional space based on the respective positions of the training data in the low-dimensional space; and
determining a probability density of the high-dimensional space based on the probability density of the low-dimensional space and the decoder portion of the autoencoder model.

2. The system of claim 1, wherein the autoencoder model and the density model are sequentially trained.

3. The system of claim 1, wherein the density model is trained with a maximum-likelihood training objective.

4. The system of claim 1, wherein the autoencoder model is trained with a reconstruction error training objective.

5. The system of claim 1, wherein the instructions are further executable for determining whether a second data set having one or more data points in the high-dimensional space are out-of-distribution with respect to the training data set based on the probability density on the low-dimensional space.

6. The system of claim 1, wherein the instructions are further executable for:
applying the encoder portion to a second data set to determine respective second positions of the second data set in the low-dimensional space;
determining a second probability density of the second data set in the low-dimensional space based on the respective second positions; and
determining whether the second data set is out-of-distribution based on a comparison of the probability density learned for the training data and the second probability density.

7. The system of claim 1, wherein the instructions are further executable for:
identifying a reconstruction error for the training data by applying the encoder portion and the decoder portion of the autoencoder to data points in the training data set;
determining a second reconstruction error for a second data set by applying the encoder portion and then the decoder portion to data points in the second data set; and
determining a similarity score of the second data set to the training data based on the reconstruction error for the training data compared to the second reconstruction error.

8. The system of claim 1, wherein the probability density of the high-dimensional space is determined by a change-of-variable formula from the low-dimensional space to the high-dimensional space.

9. The system of claim 1, wherein the autoencoder model is bijective between the high-dimensional space and low-dimensional space only on the learned manifold of the high-dimensional space.

10. The system of claim 1, wherein the high-dimensional space is an image.

11. A method for density estimation of a data set in a high-dimensional space, comprising:
training an autoencoder model based on a set of training data in a high-dimensional space, the autoencoder model having an encoder portion for encoding data in a high-dimensional space to a low-dimensional space and a decoder portion for decoding data from the low-dimensional space to a learned manifold of the high-dimensional space;
applying the encoder portion to the training data to determine respective positions of the training data in the low-dimensional space;
training a density model to learn a probability density of the low-dimensional space based on the respective positions of the training data in the low-dimensional space; and
determining a probability density of the high-dimensional space based on the probability density of the low-dimensional space and the decoder portion of the autoencoder model.

12. The method of claim 11, wherein the autoencoder model and the density model are sequentially trained.

13. The method of claim 11, wherein the density model is trained with a maximum-likelihood training objective.

14. The method of claim 11, wherein the autoencoder model is trained with a reconstruction error training objective.

15. The method of claim 11, further comprising determining whether a second data set having one or more data points in the high-dimensional space are out-of-distribution with respect to the training data set based on the probability density on the low-dimensional space.

16. The method of claim 11, further comprising:
applying the encoder portion to a second data set to determine respective second positions of the second data set in the low-dimensional space;
determining a second probability density of the second data set in the low-dimensional space based on the respective second positions; and
determining whether the second data set is out-of-distribution based on a comparison of the probability density learned for the training data and the second probability density.

17. The method of claim 11, further comprising:
identifying a reconstruction error for the training data by applying the encoder portion and the decoder portion of the autoencoder to data points in the training data set;
determining a second reconstruction error for a second data set by applying the encoder portion and then the decoder portion to data points in the second data set; and
determining a similarity score of the second data set to the training data based on the reconstruction error for the training data compared to the second reconstruction error.

18. The method of claim 11, wherein the probability density of the high-dimensional space is determined by a change-of-variable formula from the low-dimensional space to the high-dimensional space.

19. The method of claim 11, wherein the autoencoder model is bijective between the high-dimensional space and low-dimensional space only on the learned manifold of the high-dimensional space.

20. The method of claim 11, wherein the high-dimensional space is an image.
